(19) United States
(12) Patent Application Publication
(10) Pub. No.: US 2025/0182208 A1
(43) Pub. Date: Jun. 5, 2025

(54) SYSTEMS AND METHODS FOR ASSET ESCHEATMENT PREVENTION

(71) Applicant: Wells Fargo Bank, N.A., San Francisco, CA (US)

(72) Inventors: Lynne Sanders, Charlotte, NC (US); Jaclyn Olmos-Lym, San Francisco, CA (US)

(21) Appl. No.: 18/529,631

(22) Filed: Dec. 5, 2023

(51) Int. Cl. G06Q 40/06; G06F 21/31

(52) U.S. Cl. CPC G06Q 40/06; G06F 21/31

(57) ABSTRACT

Systems, apparatuses, methods, and computer program products are disclosed for asset escheatment prevention. An example method includes determining, based on a jurisdiction dataset, a dormancy status for at least one asset associated with a first digital user account. The example method also includes causing, during the dormancy period, transmission of an authentication credential request through a first digital channel to a first user device associated with the first digital user account. The example method also includes authenticating a first user associated with the first digital user account based on an authentication credential set received from the first user device in response to the authentication credential request. The example method also includes automatically performing, in response to an affirmative indication received from the first user device, a first action for the at least one asset on behalf of the user, wherein performance of the action facilitates owner-generated activity for the asset.

### BACKGROUND

In the United States, state governments require that unclaimed property escheats to the state. Escheatment is a process whereby the government takes ownership of property, including financial assets, that has been deemed abandoned by the rightful owner of the property.

### BRIEF SUMMARY

Unclaimed property may include properties held by a bank (such as bank accounts, safe deposit box contents, checks, Health Savings Accounts (HSAs), certificate of deposits (CDs), and/or other properties) for which there has not been owner-generated activity for a predetermined period of time, referred to as a “dormancy period.” In the context of bank-held properties, owner-generated activity may comprise recognized actions taken by the account holder or property owner to prevent escheatment. State governments have stringent requirements on what types of actions constitute owner-generated activity, and these requirements vary state to state (thus, the definition of inactivity also varies by jurisdiction). Additionally, there is no uniform standard regarding dormancy period length (i.e., the length of time required for a property to be escheatable) among states. For example, some state governments may define different dormancy period lengths based on the type of property.

In view of the above, maintaining owner-generated activity for bank-held properties can be challenging, especially for individuals who own properties in multiple states or reside in different states (or countries) periodically. The complexity arises from the need to adhere to different state regulations, each with its own criteria and timelines regarding dormancy periods and reporting requirements. Managing accounts across state lines involves navigating diverse legal frameworks, making it difficult for both entities (e.g., banks) and individuals to stay updated on specific actions required to prevent properties from going dormant.

Further, financial institutions may be required to attempt to contact account owners before escheating properties to the state. However, these requirements are governed by state laws and regulations and can also vary by jurisdiction. Generally, banks are typically required to notify property owners multiple times before escheating their property to a state. This series of notifications may include an initial notification when the property begins showing signs of becoming dormant, as well as follow-up notifications in the event the property owner does not respond to the initial notification. Banks may be required to attempt contact in predefined manners such as, for example, through telephone calls, postal mail, and/or email (if the account holder has provided an email address to the bank). These notifications may (e.g., in certain jurisdictions) also be required to also include sufficient information about the property, including details about the property holder and the property and in some cases instructions on how to prevent escheatment. Thus, clear and understandable language in these notifications is crucial to assisting property holders in preventing escheatment. Additionally, banks may also be required to maintain records of notifications to establish compliance with certain state regulations and/or audits.

Due to the volume of customers managed by a given bank, it may prove difficult for the bank to effectuate communications with asset owners (in the event their assets become dormant and are at risk of escheatment) in a timely manner and at scale using conventional techniques that include manpower-driven communications (e.g., postal mail, telephone calls, etc.). Further, these conventional techniques often run counter to individuals' communication preferences in an increasingly digital, online world.

In contrast to these conventional techniques, example embodiments described herein harness technology to drive an improved process for preventing asset escheatment. Example embodiments utilize artificial intelligence (AI) techniques (such as natural language processing (NLP) models and the like) to efficiently initiate and maintain contact with a customer electronically in a fashion convenient for the user (e.g., via a mobile banking application), as well as automatically perform actions on behalf of the user that are sufficient to satisfy as owner-generated activity requirements for a given jurisdiction. The present disclosure sets forth systems, methods, and apparatuses for improved asset escheatment prevention. There are many advantages of these and other embodiments described herein. For instance, example embodiments include a system that executes automated processes that integrate with databases and application programming interfaces (APIs) to retrieve up-to-date asset information in response to user queries in real-time, ensuring both the system and users have the most accurate information available. Example embodiments also provide enhanced security over traditional techniques for contacting and communicating with users regarding dormant assets. For instance, by leveraging a chatbot messaging service of a mobile banking application, both user data and asset data are kept more secure when compared with traditional means of information dissemination (e.g., phone calls or postal mail, both of which welcome eavesdropping and other interception methods, putting the user at risk). Further, the technology-centric automated processes described in example embodiments herein are inherently scalable and capable of handling high volumes of user interactions efficiently and without issue (a critical capability for large financial institutions with large customer bases) in a manner that manual techniques are not able to match.

The foregoing brief summary is provided merely for purposes of summarizing some example embodiments described herein. Because the above-described embodiments are merely examples, they should not be construed to narrow the scope of this disclosure in any way. It will be appreciated that the scope of the present disclosure encompasses many potential embodiments in addition to those summarized above, some of which will be described in further detail below.

### BRIEF DESCRIPTION OF THE FIGURES

Having described certain example embodiments in general terms above, reference will now be made to the accompanying drawings, which are not necessarily drawn to scale. Some embodiments may include fewer or more components than those shown in the figures.

FIG. 1 illustrates a system in which some example embodiments may be used for asset escheatment prevention.

FIG. 2A illustrates a schematic block diagram of example circuitry embodying an apparatus that may perform various operations in accordance with some example embodiments described herein.

FIG. 2B illustrates a schematic block diagram of example circuitry embodying a user device, partner device, or remote data source that may perform various operations in accordance with some example embodiments described herein.

FIG. 3 illustrates an example flowchart for asset escheatment prevention through digital outreach, in accordance with some example embodiments described herein.

FIG. 4 illustrates an example flowchart for interfacing with a partner device to provide escheatment notifications to users, in accordance with some example embodiments described herein.

FIG. 5 illustrates an example flowchart for providing, via a chatbot messaging service, intelligent responses to user queries, in accordance with some example embodiments described herein.

### DETAILED DESCRIPTION

Some example embodiments will now be described more fully hereinafter with reference to the accompanying figures, in which some, but not necessarily all, embodiments are shown. Because inventions described herein may be embodied in many different forms, the invention should not be limited solely to the embodiments set forth herein; rather, these embodiments are provided so that this disclosure will satisfy applicable legal requirements.

The term “computing device” refers to any one or all of programmable logic controllers (PLCs), programmable automation controllers (PACs), industrial computers, desktop computers, personal data assistants (PDAs), laptop computers, tablet computers, smart books, palm-top computers, personal computers, smartphones, wearable devices (such as headsets, smartwatches, or the like), and similar electronic devices equipped with at least a processor and any other physical components necessarily to perform the various operations described herein. Devices such as smartphones, laptop computers, tablet computers, and wearable devices are generally collectively referred to as mobile devices.

The term “server” or “server device” refers to any computing device capable of functioning as a server, such as a master exchange server, web server, mail server, document server, or any other type of server. A server may be a dedicated computing device or a server module (e.g., an application) hosted by a computing device that causes the computing device to operate as a server.

The term “mobile banking application” refers to a digital platform developed and/or managed by one or more financial institutions that allows users to manage their financial activities and accounts conveniently through their personal user devices (e.g., smartphones, tablets, and the like). A mobile banking application combines a range of features to provide users with seamless access to banking services at any time. Through a mobile banking application, a user may perform various tasks, including (but not limited to) account management (e.g., viewing real-time account balances, line item transactions, transaction histories, and other information about their accounts), fund transfers, bill payments (e.g., including scheduling one-time or recurring payments), mobile check deposits (e.g., the mobile banking application may provide the capability to deposit checks by taking photos of the checks using the user device's camera), budgeting, investment management (e.g., monitor investment portfolios and execute stock trades), card management (e.g., freeze or unfreeze debit and/or credit cards and set spending limits), loan and credit applications, customer support, a chatbot messaging service, currency conversion, and the like. A mobile banking application also provides enhanced security features. For instance, a mobile banking application may incorporate multiple security layers, including biometric authentication (e.g., facial recognition and/or fingerprint recognition), Personal Identification Numbers (PINs), and encryption to ensure the protection of sensitive financial data.

In various embodiments, a mobile banking application may interact with a server (e.g., asset escheatment prevention (AEP) system 102) to provide data to users via the mobile banking application. For instance, when a user performs an action within the mobile banking application on their user device, the mobile banking application may generate and send a request to the server (e.g., AEP system 102) that includes information about the specific action and may also include any authentication credentials of the user necessary for security. The server (e.g., AEP system 102) may then process the request and retrieve any requested data or perform requested actions. In response, the server may format certain data (e.g., retrieved data) into a structured format (e.g., JavaScript Object Notation (JSON), Extensible Markup Language (XML), and/or the like) which can be interpreted by the mobile banking application, provide the structured data to the mobile banking application which may then be displayed (e.g., via client-side processing) in a user-friendly format on an interface of the mobile banking application. In various embodiments, encryption may be used to secure data transmissions between the mobile banking application (e.g., installed on a user device) and the server (e.g., the EFM system 102). In various embodiments as discussed herein, a user may utilize a mobile banking application installed on their user device to send messages to the AEP system 102, which may in turn provide a chatbot messaging service such that the AEP system 102 generates and provides natural language responses to the messages.

The term “owner-generated activity” refers to actions proactively taken by an owner of an asset to prevent the asset from being escheated to a state (e.g., within the United States) as unclaimed property. Actions that qualify as owner-generated activity may vary state-by-state, but typically involve one or more of regular deposits or withdrawals (e.g., in the case that the asset is a financial account), updating personal information, transactions (e.g., fee payments), responding to communications from a financial institution, and/or the like.

### System Architecture

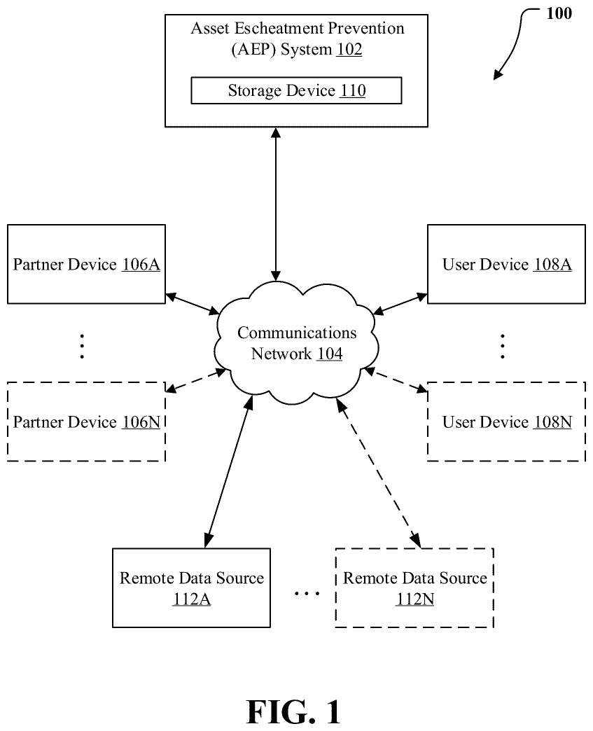

Example embodiments described herein may be implemented using any of a variety of computing devices or servers. To this end, FIG. 1 illustrates an example environment 100 within which various embodiments may operate. As illustrated, an asset escheatment prevention (AEP) system 102 may receive and/or transmit information via communications network 104 (e.g., the Internet) with any number of other devices, such as one or more of partner devices 106A-106N, user devices 108A-108N, and/or one or more remote data sources 112A-112N.

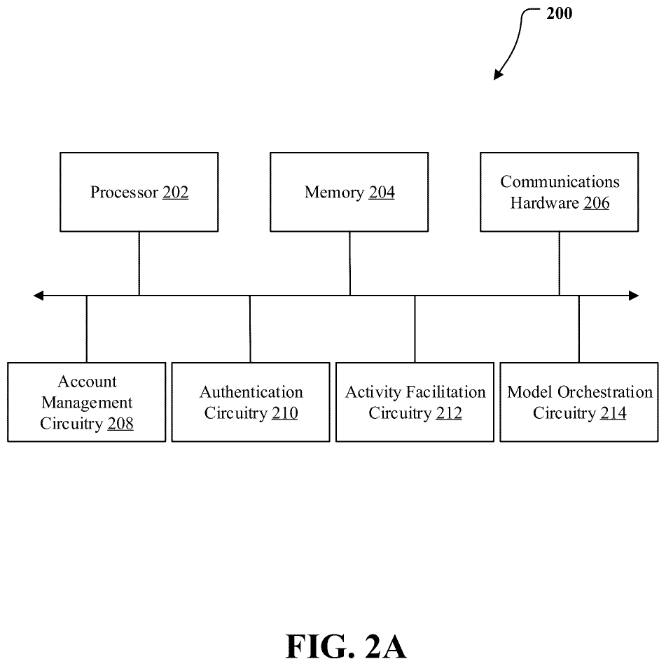

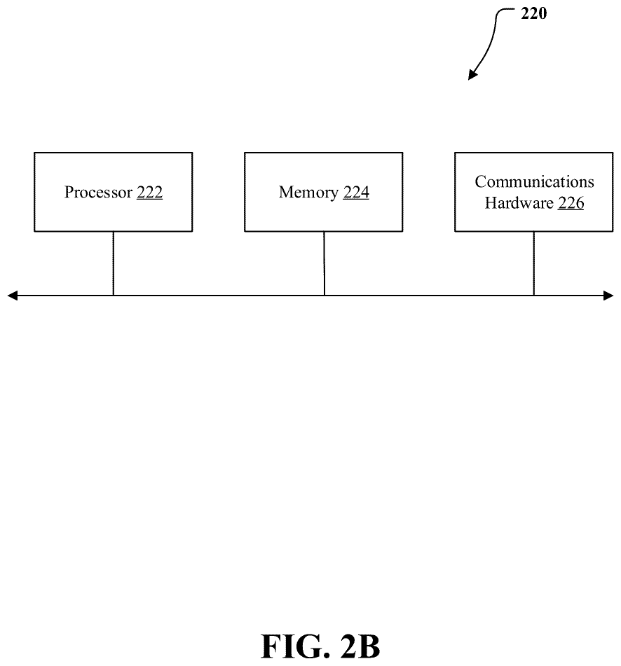

The AEP system 102 may be implemented as one or more computing devices or servers, which may be composed of a series of components. Particular components of the AEP system 102 are described in greater detail below with reference to apparatus 200 in connection with FIG. 2A.

In some embodiments, the AEP system 102 further includes a storage device 110 that comprises a distinct component from other components of the AEP system 102. Storage device 110 may be embodied as one or more direct-attached storage (DAS) devices (such as hard drives, solid-state drives, optical disc drives, or the like) or may alternatively comprise one or more Network Attached Storage (NAS) devices independently connected to a communications network (e.g., communications network 104). Storage device 110 may host the software executed to operate the AEP system 102. Storage device 110 may store information relied upon during operation of the AEP system 102, such as various models (e.g., Large Language Models (LLMs) and/or other artificial intelligence (AI) models, machine learning (ML) models, and/or the like) that may be used by the AEP system 102, data and documents to be analyzed using the AEP system 102, or the like. In addition, storage device 110 may store control signals, device characteristics, and access credentials enabling interaction between the AEP system 102 and one or more of the partner devices 106A-106N, user devices 108A-108N, or remote data sources 112A-112N.

The one or more user devices 108A-108N may be embodied by any computing devices known in the art. The one or more user devices 108A-108N need not themselves be independent devices, but may be peripheral devices communicatively coupled to other computing devices. In various embodiments, a user device (any of user devices 108A-108N) may be a personal device belonging to a user. Examples of user devices include mobile phones (e.g., smartphones), laptops, tablets, wearable devices (e.g., smartwatches), and the like. In various embodiments, a mobile banking application may be installed on a user device (any of user devices 108A-108N), through which communication with the AEP system 102 may be facilitated.

The one or more partner devices 106A-106N may be embodied by any computing devices known in the art. The one or more partner devices 106A-106N need not themselves be independent devices, but may be peripheral devices communicatively coupled to other computing devices. In various embodiments, a partner device (any of partner devices 106A-106N) may comprise a server managed by an entity that has entered into a predefined partnership with an entity managing the AEP system 102. For example, in some embodiments, the AEP system 102 may be managed by an entity such as a financial institution (e.g., a bank). In some embodiments, the financial institution may partner with other entities (e.g., corporations, organizations, merchants, retail shops, etc.) to provide various financial services to customers of the entity. These financial services may include, for example, co-branded financial cards, in-store banking services (e.g., ATMs, kiosks, etc.), loyalty programs, mobile banking integration, and/or the like. In some embodiments, a partner device (e.g., any of partner devices 106A-106N) may also comprise other devices managed by the entity, such as point-of-sale (POS) devices and the like that communicate with a server. As further discussed herein, the AEP system 102 may leverage one or more partner devices 106A-106N to communicate critical information related to dormant assets to customers.

The one or more remote data sources 112A-112N may be embodied by any computing devices known in the art. The one or more remote data sources 112A-112N need not themselves be independent devices, but may be peripheral devices communicatively coupled to other computing devices. In various embodiments, a remote data source (any of remote data sources 112A-112N) may comprise a server or other device managed by a respective financial institution that has entered into a predefined partnership with an entity managing the AEP system 102. For example, in some embodiments, the AEP system 102 may be managed by a third-party entity and a plurality of financial institutions (i.e., a consortium of financial institutions) may utilize the AEP system 102 through the third-party entity to provide escheatment prevention services to their respective customers. In this way, financial institutions may share information regarding users, assets, accounts, and the like with the AEP system 102 such that the AEP system 102 can facilitate contact and information dissemination to users based on information relating to the user collected from one or multiple banks.

### Example Implementing Apparatuses

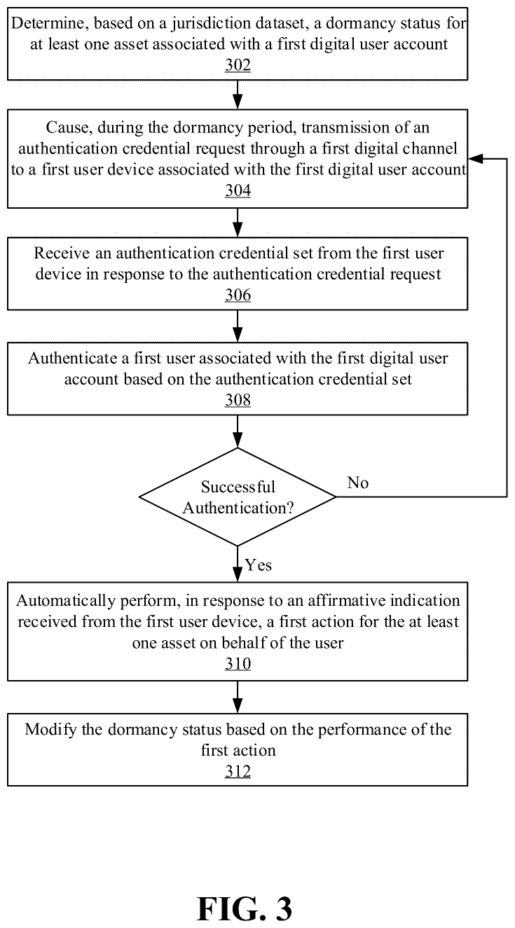

The AEP system 102 (described previously with reference to FIG. 1) may be embodied by one or more computing devices or servers, shown as apparatus 200 in FIG. 2A. The apparatus 200 may be configured to execute various operations described above in connection with FIG. 1 and below in connection with FIGS. 3-5. As illustrated in FIG. 2A, the apparatus 200 may include processor 202, memory 204, communications hardware 206, account management circuitry 208, authentication circuitry 210, activity facilitation circuitry 212, and model orchestration circuitry 214, each of which will be described in greater detail below.

The processor 202 (and/or co-processor or any other processor assisting or otherwise associated with the processor) may be in communication with the memory 204 via a bus for passing information amongst components of the apparatus. The processor 202 may be embodied in a number of different ways and may, for example, include one or more processing devices configured to perform independently. Furthermore, the processor may include one or more processors configured in tandem via a bus to enable independent execution of software instructions, pipelining, and/or multithreading. The use of the term “processor” may be understood to include a single core processor, a multi-core processor, multiple processors of the apparatus 200, remote or “cloud” processors, or any combination thereof.

The processor 202 may be configured to execute software instructions stored in the memory 204 or otherwise accessible to the processor. In some cases, the processor may be configured to execute hard-coded functionality. As such, whether configured by hardware or software methods, or by a combination of hardware with software, the processor 202 represent an entity (e.g., physically embodied in circuitry) capable of performing operations according to various embodiments of the present invention while configured accordingly. Alternatively, as another example, when the processor 202 is embodied as an executor of software instructions, the software instructions may specifically configure the processor 202 to perform the algorithms and/or operations described herein when the software instructions are executed.

Memory 204 is non-transitory and may include, for example, one or more volatile and/or non-volatile memories. In other words, for example, the memory 204 may be an electronic storage device (e.g., a computer readable storage medium). The memory 204 may be configured to store information, data, content, applications, software instructions, or the like, for enabling the apparatus to carry out various functions in accordance with example embodiments contemplated herein.

The communications hardware 206 may be any means such as a device or circuitry embodied in either hardware or a combination of hardware and software that is configured to receive and/or transmit data from/to a network and/or any other device, circuitry, or module in communication with the apparatus 200. In this regard, the communications hardware 206 may include, for example, a network interface for enabling communications with a wired or wireless communication network. For example, the communications hardware 206 may include one or more network interface cards, antennas, buses, switches, routers, modems, and supporting hardware and/or software, or any other device suitable for enabling communications via a network. Furthermore, the communications hardware 206 may include the processing circuitry for causing transmission of such signals to a network or for handling receipt of signals received from a network.

The communications hardware 206 may further be configured to provide output to a user and, in some embodiments, to receive an indication of user input. In this regard, the communications hardware 206 may comprise a user interface, such as a display, and may further comprise the components that govern use of the user interface, such as a web browser, mobile application, dedicated client device, or the like. In some embodiments, the communications hardware 206 may include a keyboard, a mouse, a touch screen, touch areas, soft keys, a microphone, a speaker, and/or other input/output mechanisms. The communications hardware 206 may utilize the processor 202 to control one or more functions of one or more of these user interface elements through software instructions (e.g., application software and/or system software, such as firmware) stored on a memory (e.g., memory 204) accessible to the processor 202.

In various embodiments, the communications hardware 206 may comprise Application Programming Interface (API) functionality to facilitate seamless communication between distinct applications with the objective of retrieving data and communicating with a user (e.g., in the form of natural language prompts and/or responses). In this regard, the communications hardware 206 may employ standardized protocols and data structures to establish efficient and secure channels with third-party applications. For instance, the AEP system 102 may generate API request (e.g., via communications hardware 206, model orchestration circuitry 214, or the like) specifying desired actions and parameters (e.g., electronic data retrieval). The communications hardware 206 may then communicate with a target application (e.g., via a partner device 106A-106N, user device 108A-108N, or remote data source 112A-112N) and, in response, receive data in a standardized format, such as, for example, asset datasets, user datasets, jurisdiction datasets, and/or the like as further discussed herein.

In addition, the apparatus 200 further comprises account management circuitry 208 that determines a dormancy status for an asset associated with a digital user account. As discussed further herein, in some embodiments, the account management circuitry 208 modifies a dormancy status for an asset associated with a digital user account based on, for example, performance of an action. Additionally, in some embodiments, the account management circuitry 208 selects a digital channel from a plurality of digital channels for transmission of an authentication credential request and/or other information. The account management circuitry 208 may utilize processor 202, memory 204, or any other hardware component included in the apparatus 200 to perform these operations, as described in connection with FIGS. 3-5 below. The account management circuitry 208 may further utilize communications hardware 206 to gather data from a variety of sources (e.g., any of partner devices 106A-106N, user devices 108A-108N, remote data sources 112A-112N, or storage device 110, as shown in FIG. 1), and/or exchange data with a user.

In addition, the apparatus 200 further comprises authentication circuitry 210 that authenticates a user associated with a digital user account based on an authentication credential set. The authentication circuitry 210 may utilize processor 202, memory 204, or any other hardware component included in the apparatus 200 to perform these operations, as described in connection with FIGS. 3-5 below. The authentication circuitry 210 may further utilize communications hardware 206 to gather data from a variety of sources (e.g., any of partner devices 106A-106N, user devices 108A-108N, remote data sources 112A-112N, or storage device 110, as shown in FIG. 1), and/or exchange data with a user. In some embodiments, the authentication circuitry 210 may authenticate a user by processing a authentication credential set received from a user device in response to an authentication credential request. In some embodiments, the authentication circuitry 210 may process the authentication credential set by comparing authentication credentials included in the authentication credential set with stored authentication credentials associated with the user (e.g., stored in memory 204 and/or storage device 110). For example, the authentication circuitry 210 may verify that an authentication credential included in the authentication credential set matches or shares enough similarity to a stored authentication credential associated with the user (e.g., the stored authentication credential being an authentication credential initially supplied by the user during registration or the like at an earlier time). In some embodiments, such as instances in which the authentication credential set includes a biometric marker (e.g., a fingerprint), the authentication circuitry 210 may confirm that the biometric marker shares enough similarities to a stored biometric marker to satisfy a predefined similarity threshold. For example, the authentication circuitry 210 may preprocess the submitted biometric marker (e.g., to remove noise, inconsistencies, or the like) and compare the preprocessed biometric marker to the stored biometric marker using a matching algorithm, such as minutiae-based matching or pattern matching. A resulting match score may then be compared with a predefined similarity threshold. In some embodiments, if the match score exceeds the predefined similarity threshold, the biometric marker may be successfully validated.

In various embodiments, the authentication circuitry 210 may leverage model orchestration circuitry 214 to perform knowledge-based authentication (KBA), wherein a user is queried (e.g., via chatbot messaging service prompts) based on personal and/or asset information. These queries may be derived from a user dataset and/or asset dataset, as further discussed herein. An authentication credential set may comprise user-supplied answers to the queries, which the authentication circuitry 210 may then compare with data contained in one or more of an asset dataset or user dataset. For successful authentication of a user, a predefined threshold of correct answers to the authentication queries may be required. In some embodiments, all answers to the authentication queries must be correct for successful authentication of a user.

Further, the apparatus 200 further comprises activity facilitation circuitry 212 that automatically performs actions for an asset on behalf of a user. In various embodiments, the actions performed by activity facilitation circuitry 212 facilitates owner-generated activity for the asset. The activity facilitation circuitry 212 may utilize processor 202, memory 204, or any other hardware component included in the apparatus 200 to perform these operations, as described in connection with FIGS. 3-5 below. The activity facilitation circuitry 212 may further utilize communications hardware 206 to gather data from a variety of sources (e.g., any of partner devices 106A-106N, user devices 108A-108N, remote data sources 112A-112N, or storage device 110, as shown in FIG. 1), and/or exchange data with a user.

Further, the apparatus 200 further comprises model orchestration circuitry 214 that generates authentication credential requests, retrieves asset datasets, and generates natural language responses to user prompts. The model orchestration circuitry 214 may utilize processor 202, memory 204, or any other hardware component included in the apparatus 200 to perform these operations, as described in connection with FIGS. 3-5 below. The model orchestration circuitry 214 may further utilize communications hardware 206 to gather data from a variety of sources (e.g., any of partner devices 106A-106N, user devices 108A-108N, remote data sources 112A-112N, or storage device 110, as shown in FIG. 1), and/or exchange data with a user.

In some embodiments, to generate authentication credential requests and natural language responses to user prompts, the model orchestration circuitry 214 may include or otherwise leverage one or more models, such as one or more natural language processing (NLP) models, such as large language models (LLMs) or the like to facilitate natural language messaging with a user (e.g., via a mobile banking application). The NLP model may be trained to generate authentication queries and understand and response to user queries related to assets. The model orchestration circuitry 214 may perform intent recognition techniques to recognize intent behind a user query, such as rule-based intent recognition, keyword matching, or the like. The model orchestration circuitry 214 may also perform entity recognition techniques to identify entities in a user query. For example, in the context of user assets, entities may comprise property names, asset types, account numbers, or other identifying information of an asset. In some embodiments, model orchestration circuitry 214 may integrate with APIs (e.g., internal or external to an entity managing AEP system 102) that store asset and/or user data in order to retrieve that data for use in natural language responses to user queries. The model orchestration circuitry 102 may generate natural language responses (i.e., responses formulated in a natural and human-understandable way for a user). To do so, the NLP model may be trained on a large amount of text data in order for the model to learn language patterns, grammar, semantics, and syntax. The model orchestration circuitry 214 may tokenize a user query (i.e., a text query received in response to the user entering the text query via their mobile banking application their user device) into numerically represented words to allow the NLP model to process the user query (e.g., understand the context, meaning, and intent of the user query).

Although components 202-214 are described in part using functional language, it will be understood that the particular implementations necessarily include the use of particular hardware. It should also be understood that certain of these components 202-214 may include similar or common hardware. For example, the account management circuitry 208, authentication circuitry 210, activity facilitation circuitry 212, and model orchestration circuitry 214 may each at times leverage use of the processor 202, memory 204, or communications hardware 206, such that duplicate hardware is not required to facilitate operation of these physical elements of the apparatus 200 (although dedicated hardware elements may be used for any of these components in some embodiments, such as those in which enhanced parallelism may be desired). Use of the term “circuitry” with respect to elements of the apparatus therefore shall be interpreted as necessarily including the particular hardware configured to perform the functions associated with the particular element being described. Of course, while the term “circuitry” should be understood broadly to include hardware, in some embodiments, the term “circuitry” may in addition refer to software instructions that configure the hardware components of the apparatus 200 to perform the various functions described herein.

Although the account management circuitry 208, authentication circuitry 210, activity facilitation circuitry 212, and model orchestration circuitry 214 may leverage processor 202, memory 204, or communications hardware 206 as described above, it will be understood that any of account management circuitry 208, authentication circuitry 210, activity facilitation circuitry 212, and model orchestration circuitry 214 may include one or more dedicated processor, specially configured field programmable gate array (FPGA), or application specific interface circuit (ASIC) to perform its corresponding functions, and may accordingly leverage processor 202 executing software stored in a memory (e.g., memory 204), or communications hardware 206 for enabling any functions not performed by special-purpose hardware. In all embodiments, however, it will be understood that account management circuitry 208, authentication circuitry 210, activity facilitation circuitry 212, and model orchestration circuitry 214 comprise particular machinery designed for performing the functions described herein in connection with such elements of apparatus 200.

As illustrated in FIG. 2B, an apparatus 220 is shown that represents an example partner device (e.g., any of partner devices 106A-106N), an example user device (e.g., any of user devices 108A-108N), or an example remote data source (e.g., any of remote data sources 112A-112N). The apparatus 220 includes processor 222, memory 224, and communications hardware 226, each of which is configured to be similar to the similarly named components described above in connection with FIG. 2A.

In some embodiments, various components of the apparatuses 200 and 220 may be hosted remotely (e.g., by one or more cloud servers) and thus need not physically reside on the corresponding apparatus 200 or 220. For instance, some components of the apparatus 220 may not be physically proximate to the other components of apparatus 220. Similarly, some or all of the functionality described herein may be provided by third party circuitry. For example, a given apparatus 200 or 220 may access one or more third party circuitries in place of local circuitries for performing certain functions.

As will be appreciated based on this disclosure, example embodiments contemplated herein may be implemented by an apparatus 200. Furthermore, some example embodiments may take the form of a computer program product comprising software instructions stored on at least one non-transitory computer-readable storage medium (e.g., memory 204). Any suitable non-transitory computer-readable storage medium may be utilized in such embodiments, some examples of which are non-transitory hard disks, compact disc read-only memories (CD-ROMs), digital versatile discs (DVDs), flash memory, optical storage devices, and magnetic storage devices. It should be appreciated, with respect to certain devices embodied by apparatus 200 as described in FIG. 2A or apparatus 220 as described in FIG. 2B, that loading the software instructions onto a computing device or apparatus produces a special-purpose machine comprising the means for implementing various functions described herein.

Having described specific components of example apparatuses 200 and 220, example embodiments are described below in connection with a series of flowcharts.

### Example Operations

Turning to FIGS. 3-5, example flowcharts are illustrated that contain example operations implemented by example embodiments described herein. The operations illustrated in FIGS. 3-5 may, for example, be performed by system device of the AEP system 102 shown in FIG. 1, which may in turn be embodied by an apparatus 200, which is shown and described in connection with FIG. 2A. To perform the operations described below, the apparatus 200 may utilize one or more of processor 202, memory 204, communications hardware 206, account management circuitry 208, authentication circuitry 210, activity facilitation circuitry 212, model orchestration circuitry 214, and/or any combination thereof. It will be understood that user interaction with the AEP system 102 may occur directly via communications hardware 206, or may instead be facilitated by a separate user device 108A-108N, partner device 106A-106N, or remote data source 112A-112N, as shown in FIG. 1, and which may have similar or equivalent physical componentry facilitating such user interaction.

Turning first to FIG. 3, example operations are shown for asset escheatment prevention. As shown by operation 302, the apparatus 200 includes means, such as processor 202, memory 204, account management circuitry 208, and/or the like, for determining, based on a jurisdiction dataset, a dormancy status for at least one asset associated with a first digital user account.

In various embodiments, the AEP system 102 may track digital user accounts for one or more entities. For example, the AEP system 102 may track digital user accounts for one or more financial institutions (e.g., banks). In various embodiments, “digital user account” refers to a user's personalized profile within a digital platform, such as a banking platform managed by a financial institution. A digital user account may comprise unique login information (e.g., a username and password combination) that allows a user to digitally access certain services and/or resources offered by the entity. For example, a user may utilize a mobile banking application on their personal device (e.g., a user device 108A-108N) to access their digital user account. In various embodiments, a digital user account may store user-specific data, activity histories, preferences, and the like. In various embodiments, a digital user account may store references to one or more user datasets (e.g., stored in memory 204 and/or storage device 110), which include data about the user of the digital account and other users linked to the digital user account in some manner (e.g., beneficiaries of assets owned by the user, individuals who jointly own an asset of the user (e.g., joint accounts), and the like). In various embodiments, a digital user account may store references to one or more asset datasets (e.g., stored in memory 204 and/or storage device 110) associated with assets owned by or otherwise associated with the user and managed by one or more financial institutions. For example, the digital user account may reference one or more assets such as funds held in financial accounts (e.g., checking accounts, savings accounts, brokerage accounts, and/or similar accounts), certificates of deposit (CDs), insurance policies, securities such as stocks and dividends, uncashed checks, real estate assets (e.g., home or business properties), contents of safe deposit boxes, and the like.

In some embodiments, for each asset, a financial institution managing the asset may store (e.g., stored in memory 204 and/or storage device 110) an asset dataset detailing information about the asset. In some embodiments, an asset dataset may comprise data regarding the particular asset. For example, in general, an asset dataset may include data such as an asset name, asset type, a date and/or time of the last instance of owner-generated activity for the asset. In the context of a financial account, for example, an asset dataset may include account identifiers (e.g., account numbers or other unique identifiers), account type, balance, transaction history (e.g., dates, descriptions, amounts, and transaction types), interest rates, and the like. In the context of real estate properties, for example, an asset dataset may include property address, property description, estimated market value, assessed value, tax amount, payment status for various required payments of the property (e.g., mortgage, property tax, etc.), mortgage data (e.g., lender, interest rate, payment schedule, etc.), insurance data (e.g., provider and coverage type), and the like. In the context of safe deposit boxes, for example, an asset dataset may include a box identifier (e.g., a box number), address of where the box is physically located, box contents (e.g., item inventory), access dates and/or times, insurance coverage, fee schedule, dates on which fee payments were made, and the like.

In various embodiments, an asset dataset may also comprise data indicating a dormancy status for the asset. In some embodiments, the dormancy status may comprise a binary classification (e.g., yes/no) of whether or not the asset is within a dormancy period. For example, an asset may enter a dormancy period after a predefined period of time has elapsed since a last instance of owner-generated activity for the asset. The time at which an asset enters a dormancy period may vary by state. For example, an asset for which no owner-generated activity has taken place for one year may be considered dormant in one state, whereas in another state, an asset for which no owner-generated activity has taken place for six months may be considered dormant. The dormancy period refers to a predetermined period of time after which, if no owner-generated activity has taken place during the dormancy period, the asset is escheated to the state. For instance, continuing with the above example, after one year without owner-generated activity, an asset may enter a dormancy period having a length of 90 days, such that the owner has 90 days to initiate owner-generated activity before the asset is escheated to the state. Dormancy period length may vary state-to-state as well.

The account management circuitry 208 may determine a dormancy status for an asset based on a jurisdiction dataset. A jurisdiction dataset may comprise data related to asset escheatment rules for a given jurisdiction. In some examples, a jurisdiction may be a state (e.g., of the United States), and in other examples, a jurisdiction may be a region different from a state, such as, for example, a county or similar type of region. In some embodiments, the account management circuitry 208 may select a jurisdiction dataset from a plurality of jurisdiction datasets (e.g., which may be stored by the AEP system 102 in, for example, storage device 110) based on data included in an asset dataset for the asset. In this regard, the apparatus 200 includes means, such as processor 202, memory 204, communications hardware 206, account management circuitry 208, and/or the like, for selecting, based on an asset dataset, a jurisdiction dataset. The account management circuitry 208 may select a jurisdiction dataset in order to determine rules regarding the escheatment process for a particular jurisdiction, such as, for example, a specific period of time without owner-generated activity that is required in order to initiate a dormancy period (and assign a dormancy status) for an asset, how long the dormancy period must last for the jurisdiction, as well as rules dictating communication attempts for an entity to follow (e.g., how many times an entity must attempt to contact the asset owner in an attempt to avoid escheatment), and similar rules. For instance, in some embodiments, account management circuitry 208 may select a jurisdiction dataset based on a location at which the asset was opened or is located in. For example, account management circuitry 208 may identify that an asset dataset for a financial account indicates that the financial account was opened in the state of Delaware. In response, account management circuitry 208 may select a jurisdiction dataset corresponding to the state of Delaware. As another example, account management circuitry 208 may identify that an asset dataset for a safe deposit box indicates that the safe deposit box is located in the state of Oregon. In response, account management circuitry 208 may select a jurisdiction dataset corresponding to the state of Oregon.

In some embodiments, the account management circuitry 208 may compare data referenced in an asset dataset with data referenced in a jurisdiction dataset in order to determine a dormancy status for an asset. For example, using an asset dataset for a given asset, account management circuitry 208 may identify a date on which the most recent instance of owner-generated activity has taken place for the asset. The account management circuitry 208 may compare the date to the current date to determine an elapsed time since the date on which the most recent instance of owner-generated activity has taken place for the asset. The account management circuitry 208 may then compare the elapsed time to a specific period of time without owner-generated activity that is required in order to initiate a dormancy period indicated by the jurisdiction dataset. In an example in which this period of time is one year, the account management circuitry 208 may determine whether the elapsed time is equal to (or greater than) one year, and, if so, determine a dormancy status for the asset indicating that the asset is within a dormancy period. Continuing with this example, if the account management circuitry 208 determines the elapsed time is less than one year, the account management circuitry 208 may determine a dormancy status for the asset indicating that the asset is not within a dormancy period.

In various embodiments, the AEP system 102 may take automatic actions to initiate contact with a user associated with an asset that has entered a dormancy period. In some embodiments, the AEP system 102 may reference a user dataset associated with the first digital user account in order to identify contact information for the user. For example, account management circuitry 208 may identify a last known physical address, email address, phone number, and/or the like for the user. In some embodiments, the account management circuitry 208 may identify whether the user has historically utilized a mobile banking application associated with the AEP system 102 in the past, and if so, may leverage the mobile banking application to initiate contact with the user.

In some examples, it may be difficult for an entity, such as a financial institution, to achieve contact with a user associated with an asset that has entered a dormancy period. In many cases, for example, it is common that the user no longer primarily banks or does business with the financial institution, and consequently has forgotten about the asset. For instance, a user who, on a whim, opened a checking account and deposited a small amount of funds to receive some cash sign-on bonus, may simply disregard the checking account after receiving the bonus, forgetting the funds initially deposited into the checking account. Such as user may have never installed a mobile banking application to track the checking account or taken any further actions to keep their contact information up-to-date.

In some embodiments, the AEP system 102 may reference data included in a user dataset to determine a digital channel through which to attempt contact with the user. In this regard, the apparatus 200 includes means, such as processor 202, memory 204, communications hardware 206, account management circuitry 208, and/or the like, for selecting a first digital channel from a plurality of digital channels based on a user dataset associated with the digital user account. A digital channel refers to a means through which to electronically contact a user. Examples of digital channels may include email, phone calls, text messages, mobile banking application chat messages, social media messages (e.g., direct messages (DMs) on a social media platform), and the like. For example, account management circuitry 208 may process the user dataset to identify one or more digital channels for which contact information is available. As one example, the user dataset may not include any contact information other than an email address. In this case, account management circuitry 208 may select email as a preferred digital channel to attempt contact with the user. In some embodiments, account management circuitry 208 may select, by default, all digital channels for which some contact information is present in the user dataset. In this manner, the AEP system 102 may make every attempt through all available digital channels to contact the user. In some embodiments, the AEP system 102 may take a ranked approach, by first attempting contact through digital channels having higher likelihood of success of establishing contact with a user. For example, if the user dataset indicates that the user has historically utilized a mobile banking application associated with the AEP system 102, the account management circuitry 208 may select the mobile banking application as the digital channel through which to first attempt contact with the user (e.g., via mobile banking application chat messages, as further discussed below). By doing so, the user may be more easily reached and more likely to respond to communications in the form of notifications (e.g., push notifications to the user's personal device) from a trusted and secure mobile banking application, rather than, for example, a phone call or text message from a number unknown to the user. In some embodiments, in response to successfully contacting the user through that digital channel, the AEP system 102 may continue to use that same digital channel to authenticate the user (i.e., verify that the AEP system 102 is talking to the rightful owner of the asset and not an impersonator), as further discussed below. However, in some embodiments, in response to successfully contacting the user through that digital channel, the AEP system 102 may direct the user to another digital channel, such as a chatbot messaging service of a mobile banking application associated with the AEP system 102, in order to authenticate the user and carry out various other operations as discussed below. For instance, the AEP system 102 may leverage communications hardware 206 to cause transmission of a message instructing the user to install and utilize the mobile banking application's chatbot messaging service to communicate with the financial institution regarding the dormant asset.

In some embodiments, AEP system 102 may leverage one or more remote data sources (e.g., any of remote data sources 112A-112N) to retrieve user datasets managed by those remote data sources in order to establish contact information for the user. Continuing with the example above in which a user has forgotten about a checking account opened for the purpose of obtaining a cash bonus, although the user does not bank with the financial institution that issued the checking account, the user may bank with one or more other financial institutions, and these financial institutions may have more robust user datasets that contain additional and/or more up-to-date contact information relating to multiple digital channels. For instance, in embodiments where the AEP system 102 is managed by a single financial institution or by a third-party entity to multiple financial institutions, the AEP system 102 may communicate requests to multiple financial institutions in instances involving an asset having entered a dormancy period in an attempt to retrieve adequate contact information for the user. In some embodiments, the user dataset stored by the AEP system 102 may be updated to include user data retrieved from one or more additional financial institutions. In this regard, the apparatus 200 includes means, such as processor 202, memory 204, communications hardware 206, and/or the like, for causing transmission, by the communications hardware, of a request for the user data to one or more devices associated with the one or more financial institutions. The request may comprise data indicating the user such that a financial institution receiving the request may retrieve the appropriate user dataset for the user. The apparatus 200 also includes means, such as processor 202, memory 204, communications hardware 206, and/or the like, for receiving user data in response to the request.

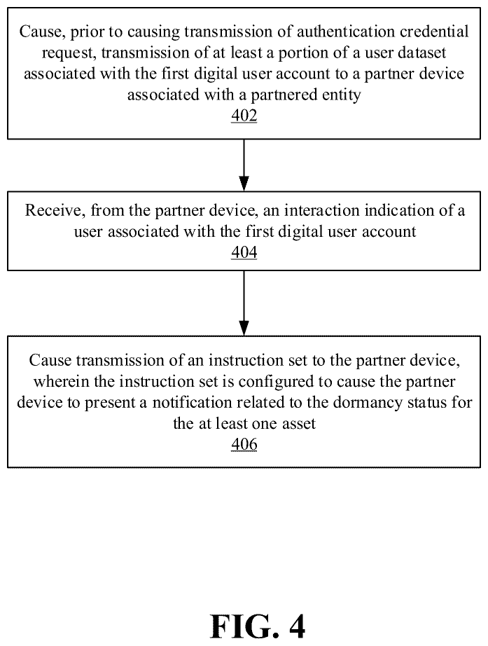

As discussed above, it may be challenging for a financial institution to contact a user when the financial institution has limited contact information for the user. In some embodiments, to increase the odds of successfully contacting a user, the AEP system 102 may leverage one or more partner devices (e.g., any of partner devices 106A-106N) to identify instances in which a user is present within a partner location and communicate information to the user concerning their asset which has entered a dormancy period. Turning briefly to FIG. 4, example operations are shown for interfacing with a partner device to provide escheatment notifications to users.

As discussed above, a partner device (e.g., any of partner devices 106A-106N) may comprise a device managed by an entity (such as a merchant) that has entered into a predefined partnership with an entity (such as a financial institution) managing the AEP system 102 to provide various financial services to customers of the entity. As also discussed above, in some embodiments, a partner devices (e.g., partner devices 106A-106N) may comprise various devices managed by the entity, such as servers, as well as other devices such as internet-of-things (IoT) devices, security devices, point-of-sale (POS) devices, and the like that may communicate with the server.

For example, in some embodiments, terms of the predefined partnership between the financial institution and a partnered entity, such as merchant, may include communications from the merchant to the financial institution regarding particular users who are actively utilizing partner devices within a location associated with the merchant, such that the financial institution may timely communicate information related to dormant assets to the users through the partner devices. In order to do so, the AEP system 102 may communicate certain user data of a user to one or more partnered devices in response to determining a dormancy status for at least one asset associated with a digital account of the user. In this regard, as shown by operation 402, the apparatus 200 includes means, such as processor 202, memory 204, communications hardware 206, and/or the like, for causing transmission of at least a portion of a user dataset associated with the first digital user account to a partner device associated with a partnered entity. By doing so, the one or more partner devices may begin monitoring partner device interactions to identify instances in which the user is likely to be interacting with a partner device. For example, devices of a merchant (such as a grocery retailer) may identify an instance in which a user is paying for a purchase at a grocery store based on a reading of the user's loyalty card (e.g., a discount card or the like that is issued by the merchant to customers) or financial card (e.g., a credit or debit card) at a partner device, such as a point-of-sale (POS) device stationed in the grocery store. The partner device may then communicate information regarding the instance to the AEP system 102. In this regard, as shown by operation 404, the apparatus 200 includes means, such as processor 202, memory 204, communications hardware 206, and/or the like, for receiving, from a partner device, an interaction indication of a user associated with the first digital user account, wherein the payment indication indicates an interaction performed at a partner device by the user. For example, in some embodiments, the interaction indication may indicate a payment performed at a particular partner device, such as a POS device, by the user (i.e., the user has swiped their debit or credit card at a POS device). As another example, in some embodiments, the interaction indication may indicate a reading of data associated with the user, such as by way of scanning of a loyalty card at a POS device, a scanning of indicia (e.g., a Quick Response (QR) code or the like) displayed on a user device at the POS device, and/or the like. The interaction may contain data about the user (such as, for example, a unique identifier for the user known to both the partner device(s) and AEP system 102), such that the AEP system 102 can use the data to tailor communications to the user in response to the interaction indication.

As shown by operation 406, the apparatus 200 includes means, such as processor 202, memory 204, communications hardware 206, and/or the like, for causing, transmission of an instruction set to the partner device. The instruction set may be transmitted to the partner device in response to receiving the interaction indication. The instruction set may be configured to cause the partner device (and/or one or more associated partner devices) to present a notification related to the dormancy status for at least one asset associated with the user. For example, in some embodiments, the instruction set may configure a POS device to display (via a display screen of the POS device or the like) a message tailored to the user regarding a dormant asset. In some embodiments, the instruction set may configure a POS device to output (e.g., print on a physical receipt for the user's purchase) a message tailored to the user regarding a dormant asset. In some embodiments, the message may be a general message notifying the customer to contact the bank about a dormant asset without specifying details about the asset. In some embodiments, the message may include details about the asset. In this way, a financial institution can leverage partnerships with other entities a user may frequently conduct business with in order to provide communications to users (for example, in the event limited contact information is available) through a trusted medium to implore users to communicate with the financial institution regarding their asset(s).

Returning to FIG. 3, as shown by operation 304, the apparatus 200 includes means, such as processor 202, memory 204, communications hardware 206, authentication circuitry 210, model orchestration circuitry 214, and/or the like, for causing, during the dormancy period, transmission of an authentication credential request through a first digital channel to a first user device associated with the first digital user account. In some embodiments, the first digital channel may be a digital channel selected by the account management circuitry 208 to attempt initial contact with the user, as discussed above. In some embodiments, in response to successfully contacting the user through a particular digital channel, the AEP system 102 may continue to use that same digital channel to authenticate the user. For example, if the AEP system 102 successfully contacts a user through short message service (SMS) text messages, the AEP system 102 may continue to use SMS text messages to perform KBA by requesting and receiving various personal identifiable information (PII) through SMS text messages. However, as discussed above and in some embodiments, in response to successfully contacting the user through that digital channel, the AEP system 102 may direct the user to another digital channel, such as a chatbot messaging service of a mobile banking application associated with the AEP system 102. By doing so, the AEP system 102 is enabled to capture a more robust set of authentication credentials, including, for example, biometric factors and the like. Further, security of communications is enhanced through using a mobile banking application (which offers various security features, such as data encryption and the like) when compared with text messaging or other less secure channels.

In some embodiments, causing transmission of the authentication credential request may take place through a chatbot messaging service of the mobile banking application and may involve generating a series of authentication queries based on a user dataset associated with the first digital account. In this regard, the apparatus 200 includes means, such as processor 202, memory 204, authentication circuitry 210, model orchestration circuitry 214, and/or the like, for generating an authentication request. The apparatus 200 includes means, such as processor 202, memory 204, authentication circuitry 210, model orchestration circuitry 214, and/or the like, for generating a series of authentication queries based at least on a user dataset associated with the first digital account. For example, in some embodiments, model orchestration circuitry 214 may leverage an NLP model or the like to generate personalized queries directed to the user based on various PII contained in the user dataset (e.g., name, home address, email, phone number, etc.). In some embodiments, the personalized authentication queries may include short answer queries (which the user must provide a textual response to) and/or multiple choice authentication queries. For example, an example multiple choice authentication query may ask the user which address of four different address choices is historically associated with the user. For example, the model orchestration circuitry 214 may generate three false answers (containing fake or incorrect addresses) and one correct answer (containing an address indicated by the user dataset). In some embodiments, the series of authentication queries may also be based on an asset dataset for the dormant asset associated with the digital user account. For example, model orchestration circuitry 214 may leverage the NLP model or the like to generate personalized queries directed to the user based on information about their dormant asset. These queries may include questions about the asset type (e.g., “is it a checking or savings account?”), asset location (e.g., “what state is your safe deposit box located in?”), and/or other data which may be interpreted from the asset dataset by the model orchestration circuitry 214. In addition to KBA-related queries, some queries may prompt the user to provide biometric data. In this case, such a query may include instructions interpretable by the mobile banking application the user device to prompt the user to input a biometric authentication credential, such as, for example, a fingerprint scan using a fingerprint reader on their user device (such as a smartphone or the like), a face or iris scan using a camera and display screen of their user device, one or more body readings (e.g., pulse, blood oxygen, temperature, etc. from a sensor of the user device, such as a smartwatch) and/or the like.

Additionally, in some embodiments, the model orchestration circuitry 214 may generate one or more authentication queries based on contextual data or events associated with the digital user account of the user. For example, such queries may be related to events, such as financial transactions related to recent purchases (e.g., viewable to the user via their mobile banking application). As one example, an authentication query may include a question such as “Where was your more recent transaction conducted?” As another example, an authentication query may include a question such as “What was the dollar amount of your most recent automated teller machine (ATM) withdrawal?”

In response to causing transmission of the authentication credential request, the AEP system 102 may receive an authentication credential set. As shown by operation 306, the apparatus 200 includes means, such as processor 202, memory 204, communications hardware 306, and/or the like, for receiving an authentication credential set from the first user device in response to the authentication credential request. In some embodiments, an authentication credential set comprises a set of authentication credentials corresponding to user inputs (e.g., biometric factors and/or answers to the authentication queries) provided by the user in response to the series of authentication queries.

In various embodiments, the AEP system 102 may then authenticate the user by verifying the authentication credentials included in the authentication credential set. In this regard, as shown in operation 308, the apparatus 200 includes means, such as processor 202, memory 204, authentication circuitry 210, or the like, for authenticating, a first user associated with the first digital user account based on an authentication credential set received from the first user device in response to the authentication credential request. In some embodiments, the authentication circuitry 210 may verify an authentication credential by performing a comparison of the authentication credential to a stored credential associated with the digital user account. For example, the digital payment management system 102 may verify that the credential submitted with the digital withdrawal request matches or satisfies a similarity threshold a stored credential associated with the digital user account. As one example, a user may be asked (by way of an authentication query) to provide the last four digits of their social security number. The authentication circuitry 210 may compare an authentication credential corresponding to four digits input by the user in response to the authentication query to a field of the user dataset that includes the last four digits of the social security number (i.e., a stored credential). As another example, when prompted with a multiple choice question wherein each candidate answer is labeled with a respective letter (e.g., A, B, C, D), a user may reply to the authentication query by providing a letter corresponding to what they believe is the correct answer. The authentication circuitry 210, in some embodiments, may then leverage model orchestration circuitry 214 (having generated the authentication query) to determine whether the provided answer is correct.

In some embodiments, such as instances in which the authentication credential set includes a biometric marker, the authentication circuitry 210 may determine whether the biometric marker shares enough similarity to a stored biometric marker (e.g., submitted to the AEP system 102 and/or entity managing the AEP system 102 at an earlier time, such as during registration of the digital user account or the like) such that the comparison satisfies a predefined similarity threshold. For example, the authentication circuitry 210 may preprocess the biometric marker included in the authentication credential set (e.g., to remove noise, inconsistencies, or the like) and compare the preprocessed biometric marker to the stored biometric marker using a matching algorithm, such as a minutiae-based matching or pattern matching algorithm. A resulting match score (e.g., a value between 0 and 1, with a value closer to 1 indicating an exact or definite match) produced by the algorithm may then be compared with a predefined similarity threshold. In some embodiments, if the match score exceeds the predefined similarity threshold, the biometric marker may be successfully verified.

In some embodiments, the authentication circuitry 210 may verify each authentication credential included in the authentication credential set. In some embodiments, the authentication circuitry 210 may verify a subset of authentication credentials included in the authentication credential set. In some embodiments, the authentication circuitry 210 may determine an authentication score that is based on a number of verified authentication credentials and unverified authentication credentials. In some examples, a verified authentication credential may comprise a correct answer to an authentication query, whereas an unverified authentication credential may comprise an incorrect answer to an authentication query. In some embodiments, if the authentication score satisfies a predefined threshold (e.g., meets or exceeds a predefined value)

In some embodiments, the authentication credential circuitry 210 may apply weighted values to certain authentication credentials which may influence the determination of the authentication score. For example, an authentication credential corresponding to the last four digits of a social security number may be assigned a higher weighted value than and authentication credential corresponding to an answer to an authentication query inquiring about an asset type associated with the dormant asset. In this regard, for example, an authentic user should know and be able to provide the last four digits of their social security number, however, the user may simply not recall the type of asset that has entered the dormancy period, due to no longer banking with the financial institution or similar reason.

As shown in FIG. 3, in response to an unsuccessful authentication of the user, the method may return to operation 304, wherein another authentication credential request is provided to the user device. In this manner, the user may have the option to verify their identity to the AEP system 102 again. In some embodiments, a new authentication credential request may be generated by the model orchestration circuitry 214 which may comprise one or more new authentication queries not previously presented to the user.

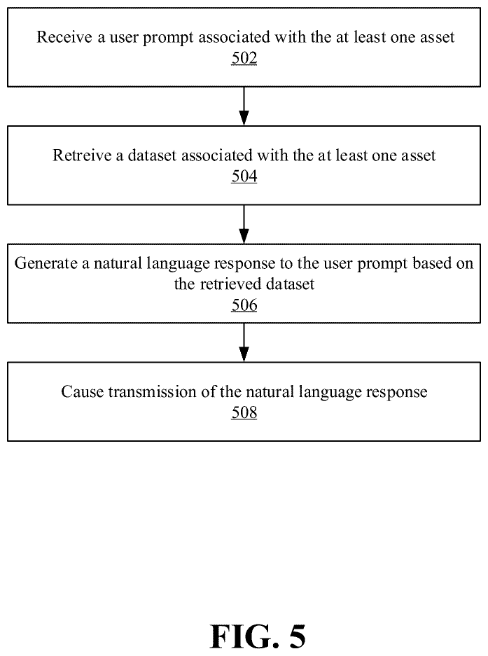

In some embodiments, in response to a successful authentication of the user, the AEP system 102 may notify the user (e.g., via the digital channel used to provide the authentication credential request) of the successful authentication. As one example, through a chatbot messaging service, the model orchestration circuitry 214 may generate a message indicating the successful authentication of the user as well as a message providing information regarding the dormant asset. In some embodiments, the AEP system 102 may leverage the chatbot messaging service of the mobile banking application to communicate various information about the dormant asset (or more generally, the dormancy period and/or rules surrounding escheatment of assets to a given jurisdiction) in response to queries from the user. Turning briefly to FIG. 5, example operations are shown for providing, via a chatbot messaging service, intelligent responses to user queries.

As shown by operation 502, the apparatus 200 includes means, such as processor 202, memory 204, communications hardware 206, model orchestration circuitry 214, and/or the like, for receiving a user prompt associated with the at least one asset. In some embodiments, a user prompt may comprise a text input (e.g., text typed on a keyboard) which may be used as an input prompt for an NLP model (such as, for example, an LLM or the like). As discussed above, an NLP model (e.g., of model orchestration circuitry 214) may be trained on large datasets that include a wide variety of text from various sources, which enables the NLP model to understand grammar, context, and the relationships between words and sentences. For example, the text input may be a question the user has regarding their dormant asset, such as what the asset is, when it was created, a balance inquiry, or the like. In some embodiments, a user prompt may be received as automatic speech recognition (ASR) output data representing a spoken user utterance. For instance, a user may speak a question out loud (captured by a microphone of their user device, for example) to the chatbot messaging service of the mobile banking application, and this audio input may be processed (e.g., at the user device) for transmission to the AEP system 102.

In some embodiments, the model orchestration circuitry 214 may leverage an NLP model (e.g., an LLM) that is trained to output a text-based action plan formatted into a series of computer-executable actions (including API calls to various internal or external subsystems) that may be performed in order to process the user prompt. In various embodiments, the model orchestration circuitry 214, using the NLP model, may perform a recursive process in which an initial action plan may be executed (e.g., by making various API calls to API providers to receive results/responses), and the responses may be used to generate updated prompts which may then be input into the NLP model for generation of an updated action plan. The action plan may use a series of function calls to take the necessary actions used to respond to the natural language request. These function calls may be used to retrieve data from user datasets, asset datasets, and/or jurisdiction datasets stored by AEP system 102 or by one or more external systems (e.g., remote data sources 112A-112N, partner devices 106A-106N, and/or the like).

As shown by operation 504, the apparatus 200 includes means, such as processor 202, memory 204, communications hardware 206, model orchestration circuitry 214, and/or the like, for retrieving, by model orchestration circuitry, a dataset associated with the at least one asset. The dataset may comprise one or more of an asset dataset, user dataset, or jurisdiction dataset. The model orchestration circuitry 214 may retrieve (e.g., via one or more API calls) an appropriate dataset based on the nature of the user prompt. For example, if the user prompt asks “when did I open that account?” (referring to a dormant financial account), the model orchestration circuitry 214 may generate an API request to retrieve the asset dataset or a portion of the asset dataset indicating an account opening date. In response, the model orchestration circuitry 214 may receive the account opening date and provide the date to the NLP model in order for the model to generate a natural language response to the user prompt. As another example, if the user prompt asks “how long before the asset is escheated to the state?,” the model orchestration circuitry 214 may generate an API request to retrieve a jurisdiction dataset (or a portion of the jurisdiction dataset indicating dormancy period length for the particular state) and provide the date to the NLP model in order for the model to generate a natural language response to the user prompt.

As shown by operation 506, the apparatus 200 includes means, such as processor 202, memory 204, model orchestration circuitry 214, and/or the like, for generating a natural language response to the user prompt based on the retrieved dataset. For example, the model orchestration circuitry 214 may leverage the NLP model (e.g., an LLM) to generate a natural language response to the user prompt. For example, the response may be formatted in a casual, human-understandable manner and provided via the chatbot messaging service to seem as though the user is communicating with another human rather than a computing system. As one example, a natural language response to the user prompt “how long before the asset is escheated to the state?” may be “You've got 14 days to take action on the asset before it is escheated. Would you like to do so now?” As another example, a natural language response to the user prompt “when did I open that account?” may be “The account was opened in the summer of last year, specifically on July 25th.”

As shown by operation 508, the apparatus 200 includes means, such as processor 202, memory 204, communications hardware 206, model orchestration circuitry 214, and/or the like, for causing transmission of the natural language response. For example, the response may be provided as a message to the user via the chatbot messaging service. It is to be appreciated that a user may provide any number of user prompts to the AEP system 102 (by way of a chatbot messaging service, for example) regarding questions about their dormant asset.

Turning back to FIG. 3, after a successful authentication of the user, the AEP system 102 may perform an action to facilitate an instance of owner-generated activity for the asset. In this regard, as shown by operation 310, the apparatus 200 includes means, such as processor 202, memory 204, communications hardware 206, activity facilitation circuitry 212, and/or the like, for automatically performing, in response to an affirmative indication received from the first user device, a first action for the at least one asset on behalf of the user. The performance of the action may facilitate owner-generated activity for the asset. In some embodiments, the AEP system 102 may select and recommend an action (e.g., from a set of actions) to be performed based on a jurisdiction dataset corresponding to a state associated with the asset (e.g., a state in which the asset originated or is located). For example, the selected action may correspond to an action that satisfies owner-generated activity defined by the jurisdiction dataset.

As one example, in some jurisdictions, the act of contacting the asset owner and in turn receiving an indication or request from the asset owner for the financial institution to maintain the asset may be enough to satisfy owner-generated activity requirement, in which case the first action may comprise recording and storing (e.g., in storage device 110) data which details an instance of the contact and interaction with the asset owner. In other jurisdictions, for example, an owner-generated activity requirement may involve a payment or funds transfer. For instance, in an example in which the asset is a safe deposit box, a fee payment for the safe deposit box may qualify as owner generated activity. In another example in which the asset is a financial account, a deposit to the financial account or a payment from the financial account to another account may qualify as owner-generated activity. In any case, the AEP system 102 may be configured to automatically perform actions that qualify as owner-generated activity on behalf of the user (e.g., in response to the user providing an affirmative indication that they would like these actions performed to avoid escheatment) such that the user does not need to take further action themselves. In doing so, the AEP system 102 may improve performance of multiple computing systems by preserving computational resources, such as network bandwidth, processor and memory utilization, and the like. For example, by automatically performing actions on behalf of the user that qualify as owner-generated activity, one or more assets are thus prevented from being escheated to a state, which eliminates significant data transmissions (that include data regarding the asset(s) and other required escheatment information) between devices of the financial institution and computing devices of, for example, a state government or other regulatory body that would otherwise be performed if the asset(s) did escheat. Further, if these actions were not automatically performed by the AEP system 102 on behalf of the user, the user would need to take action themselves, which may involve interacting with one or more additional computing systems (e.g., one or more computing devices of a physical branch of the financial institutions) to authenticate themselves a second time and perform actions, such as payment transfer or the like. As the AEP system 102 has already authenticated the user (e.g., during a chat session of the chatbot messaging service), subsequent authentications of the user (which may involve complex and computationally-intensive biometric data analysis and the like) at a later time through different channels are avoided, thus preserving computational resources and freeing these resources to perform other tasks.

In some embodiments, for example, the action performed by the AEP system 102 may be a payment transfer in connection with the at least one asset. This may include, for example, a deposit to or withdrawal from a financial account asset, a fee payment for the asset (e.g., an overdue safe deposit box fee. In this regard, the apparatus 200 includes means, such as processor 202, memory 204, activity facilitation circuitry 212, and/or the like, for causing a payment transfer in connection with at least one asset. For example, the model orchestration circuitry 214 may generate a prompt for the user recommending a particular action. In the context of a financial account asset, his action may be, for example, a donation to a charity of the user's choice (e.g., a donation of funds from the financial account asset), a payment transfer to another financial account (e.g., a transfer of funds from the financial account to a secondary financial account associated with the user or another individual), or the like. In response to an affirmative indication that the user wishes the AEP system 102 to perform an action on their behalf, the activity facilitation circuitry 212 may then perform or otherwise initiate performance of the action. For instance, the activity facilitation circuitry 212 may initiate a funds transfer with a payment server or the like on behalf of the user.

As shown by operation 312, the apparatus 200 means, such as processor 202, memory 204, account management circuitry 208, and/or the like, for modifying the dormancy status based on the performance of the first action. For example, the account management circuitry 208 may update an internal subsystem of the financial institution that tracks user assets to remove the dormancy status in response to performance of an action that facilitates owner-generated activity for the asset. By doing so, a time period for the asset may be reset, such that the asset is no long in imminent jeopardy of being escheated to the state.

FIGS. 3, 4, and 5 illustrate operations performed by apparatuses, methods, and computer program products according to various example embodiments. It will be understood that each flowchart block, and each combination of flowchart blocks, may be implemented by various means, embodied as hardware, firmware, circuitry, and/or other devices associated with execution of software including one or more software instructions. For example, one or more of the operations described above may be implemented by execution of software instructions. As will be appreciated, any such software instructions may be loaded onto a computing device or other programmable apparatus (e.g., hardware) to produce a machine, such that the resulting computing device or other programmable apparatus implements the functions specified in the flowchart blocks. These software instructions may also be stored in a non-transitory computer-readable memory that may direct a computing device or other programmable apparatus to function in a particular manner, such that the software instructions stored in the computer-readable memory comprise an article of manufacture, the execution of which implements the functions specified in the flowchart blocks.

The flowchart blocks support combinations of means for performing the specified functions and combinations of operations for performing the specified functions. It will be understood that individual flowchart blocks, and/or combinations of flowchart blocks, can be implemented by special purpose hardware-based computing devices which perform the specified functions, or combinations of special purpose hardware and software instructions.

### CONCLUSION

As described above, example embodiments provide methods and apparatuses that enable improved asset escheatment prevention. Example embodiments thus provide tools that overcome the problems faced by conventional approaches to contacting and facilitating asset escheatment avoidance. By avoiding the need to manually authenticate users and communicate detailed instructions on how to avoid escheatment and in turn relying on asset owners themselves to perform the actions in the correct manner, example embodiments thus save time and resources (both computational and manpower), while also eliminating the possibility of human error common in conventional approaches. Moreover, embodiments described herein avoid user confusion or distrust of communications intended to assist the user with asset escheatment prevention. For example, by utilizing a chatbot messaging service of a trusted and secure mobile banking application, and moreover providing natural language prompts and responses to the user via the chatbot messaging service, users may be made more at ease and thus more willing to engage with the communications and prevent their assets from becoming escheated, which leads to a reduction in assets being escheated to the states, and therefore less impact on digital resources (e.g., network bandwidth and the like) that would otherwise be utilized during the escheatment process. Additionally, by automating functionality that has historically required human analysis and labor, such as authentication of asset owners, provision of details regarding dormant assets to users, and manual performance of action(s) to prevent escheatment, the speed and consistency of the operations (including automatic performance of one or more actions to prevent escheatment) performed by example embodiments unlocks many potential new functions that have historically not been available, such as the ability to conduct near-real-time resolution of user inquiries regarding dormant assets in a clear, concise, and informative manner (e.g., via natural language responses delivered via a chatbot messaging service).

Many modifications and other embodiments of the inventions set forth herein will come to mind to one skilled in the art to which these inventions pertain having the benefit of the teachings presented in the foregoing descriptions and the associated drawings. Therefore, it is to be understood that the inventions are not to be limited to the specific embodiments disclosed and that modifications and other embodiments are intended to be included within the scope of the appended claims. Moreover, although the foregoing descriptions and the associated drawings describe example embodiments in the context of certain example combinations of elements and/or functions, it should be appreciated that different combinations of elements and/or functions may be provided by alternative embodiments without departing from the scope of the appended claims. In this regard, for example, different combinations of elements and/or functions than those explicitly described above are also contemplated as may be set forth in some of the appended claims. Although specific terms are employed herein, they are used in a generic and descriptive sense only and not for purposes of limitation.

What is claimed is:

1. A method comprising:
determining, by account management circuitry and based on a jurisdiction dataset, a dormancy status for at least one asset associated with a first digital user account, the dormancy status indicating that the at least one asset is within a dormancy period;
causing, by communications hardware and during the dormancy period, transmission of an authentication credential request through a first digital channel to a first user device associated with the first digital user account;
authenticating, by authentication circuitry, a first user associated with the first digital user account based on an authentication credential set received from the first user device in response to the authentication credential request; and
automatically performing, by activity facilitation circuitry and in response to an affirmative indication received from the first user device, a first action for the at least one asset on behalf of the user, wherein performance of the action facilitates owner-generated activity for the asset.

2. The method of claim 1, further comprising:
modifying, by the account management circuitry, the dormancy status based on the performance of the first action.

3. The method of claim 1, wherein automatically performing the first action comprises:
causing, by the activity facilitation circuitry, a payment transfer in connection with the at least one asset.

4. The method of claim 3, wherein the at least one asset comprises a financial account, and wherein the payment transfer comprises a transfer of funds from the financial account to a second financial account.

5. The method of claim 1, wherein the jurisdiction dataset defines criteria for the owner-generated activity and the dormancy status in accordance with a first jurisdiction.

6. The method of claim 1, further comprising:
selecting, by the account management circuitry, the first digital channel from a plurality of digital channels based on a user dataset associated with the first digital user account.

7. The method of claim 6, wherein the first digital user account is managed by a first financial institution and wherein the user dataset comprises user data stored by one or more financial institutions different from the first financial institution, wherein the method further comprises:
causing transmission, by the communications hardware, of a request for the user data to one or more devices associated with the one or more financial institutions; and
receiving, by the communications hardware, the user data in response to the request.

8. The method of claim 1, further comprising:
receiving, by the communications hardware, a user prompt associated with the at least one asset;
retrieving, by model orchestration circuitry, a dataset associated with the at least one asset;
generating, by the model orchestration circuitry, a natural language response to the user prompt based on the retrieved dataset; and
causing, by the communications hardware, transmission of the natural language response.

9. The method of claim 1, further comprising:
generating, by model orchestration circuitry, the authentication credential request, wherein generating the authentication credential request comprises:
generating, by model orchestration circuitry, a series of authentication queries based on a user dataset associated with the first digital account;
wherein the authentication credential set comprises user inputs in response to the series of authentication queries.

10. The method of claim 1, further comprising:
causing, by the communications hardware and prior to causing transmission of authentication credential request, transmission of at least a portion of a user dataset associated with the first digital user account to a partner device associated with a partnered entity;
receiving, by the communications hardware and from the partner device, an interaction indication of a user associated with the first digital user account, wherein the payment indication indicates a payment performed at the partner device by the user; and
causing, by the communications hardware, transmission of an instruction set to the partner device, wherein the instruction set is configured to cause the partner device to present a notification related to the dormancy status for the at least one asset.

11. An apparatus comprising:
account management circuitry configured to determine, based on a jurisdiction dataset, a dormancy status for at least one asset associated with a first digital user account, the dormancy status indicating that the at least one asset is within a dormancy period;
communications hardware configured to cause, during the dormancy period, transmission of an authentication credential request through a first digital channel to a first user device associated with the first digital user account;
authentication circuitry configured to authenticate a first user associated with the first digital user account based on an authentication credential set received from the first user device in response to the authentication credential request; and
activity facilitation circuitry configured to automatically perform, in response to an affirmative indication received from the first user device, a first action for the at least one asset on behalf of the user, wherein performance of the action facilitates owner-generated activity for the asset.

12. The apparatus of claim 11, wherein the account management circuitry is further configured to modify the dormancy status based on the performance of the first action.

13. The apparatus of claim 11, wherein the activity facilitation circuitry automatically performs the first action by causing a payment transfer in connection with the at least one asset.

14. The apparatus of claim 13, wherein the at least one asset comprises a financial account, and wherein the payment transfer comprises a transfer of funds from the financial account to a second financial account.

15. The apparatus of claim 11, wherein the jurisdiction dataset defines criteria for the owner-generated activity and the dormancy status in accordance with a first jurisdiction.

16. The apparatus of claim 11, wherein the account management circuitry is further configured to select the first digital channel from a plurality of digital channels based on a user dataset associated with the first digital user account.

17. The apparatus of claim 16, wherein the first digital user account is managed by a first financial institution and wherein the user dataset comprises user data stored by one or more financial institutions different from the first financial institution, wherein the communications hardware is further configured to:
cause transmission of a request for the user data to one or more devices associated with the one or more financial institutions; and
receive the user data in response to the request.

18. The apparatus of claim 11,
wherein the communications hardware is further configured to receive a user prompt associated with the at least one asset;
wherein the model orchestration circuitry is further configured to:
retrieving, by model orchestration circuitry, a dataset associated with the at least one asset, and
generating, by the model orchestration circuitry, a natural language response to the user prompt based on the retrieved dataset; and
wherein the communications hardware is further configured to cause transmission of the natural language response.

19. The apparatus of claim 11,
wherein the model orchestration circuitry is further configured to generate the authentication credential request, wherein the model orchestration circuitry generates the authentication credential request by:
generating a series of authentication queries based on a user dataset associated with the first digital account,
wherein the authentication credential set comprises user inputs in response to the series of authentication queries.

20. The apparatus of claim 11, wherein the communications hardware is further configured to:
cause, prior to causing transmission of authentication credential request, transmission of at least a portion of a user dataset associated with the first digital user account to a partner device associated with a partnered entity;
receive, from the partner device, an interaction indication of a user associated with the first digital user account, wherein the payment indication indicates a payment performed at the partner device by the user; and
cause transmission of an instruction set to the partner device, wherein the instruction set is configured to cause the partner device to present a notification related to the dormancy status for the at least one asset.
